(19) United States
(12) Patent Application Publication
(10) Pub. No.: US 2014/0071378 A1
(43) Pub. Date: Mar. 13, 2014

(54) Backlight unit, LCD module, and LCD device

(71) Applicant: Gege Zhou, Shenzhen (CN)

(72) Inventor: Gege Zhou, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/697,359

(22) PCT Filed: Sep. 13, 2012
(86) PCT No.: PCT/CN2012/081321

§ 371 Date: Nov. 11, 2012

(30) Foreign Application Priority Data
Sep. 10, 2012 (CN) CN 201210331870.8

(51) Int. Cl. G02F 1/1335; F21V 8/00

(52) U.S. Cl. CPC G02F 1/133608; G02B 6/0001
USPC 349/62; 362/606

(57) ABSTRACT

The present invention provides a light leakage prevention backlight unit comprising: a backplane for supporting the backlight unit; a heat dispassion bar disposed on the backplane and comprising a horizontal plate having an edge and a vertical plate extending from the edge of the horizontal plate and having an outer side and an inner side; a light bar disposed at the inner side of the vertical plate of the heat dispassion bar; a reflective plate, a light guide plate, and an optical film group sequentially disposed on the horizontal plate of the heat dispassion bar from bottom to top, wherein a light incident surface of the light guide plate is directly opposite to the light bar; an outer case disposed at the outer side of the heat dispassion bar and comprising multiple platforms, wherein the platforms are supported by the vertical plate of the heat dispassion bar, and some of the platforms are disposed above the outer peripheral of the optical film group; and a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together. The present invention also provides a light leakage prevention LCD module and LCD device. The present invention could effectively reduce the light leakage phenomenon.

The claims of this application have submitted to the State Intellectual Property Office of the People's Republic of China (SIPO) on Sep. 10, 2012, Application No. 201210331870.8. The priority right based on the China application has a title of “a backlight unit, an LCD module, and an LCD device”. The entire contents of the above-mentioned patent application will be incorporated in the present application through citing.

### BACKGROUND OF THE INVENTION

1. Field of the Invention

The present invention relates to the technology field of a liquid crystal display (LCD), and in particular relates to a backlight unit, an LCD module, and an LCD device.

2. Description of Related Art

The main components of an LCD device include: a front housing, a rear housing, an LCD module, system components and etc. Wherein, the main components of the LCD module comprise: a front frame, an LCD glass panel, a backlight unit and etc. Wherein, as shown in FIG. 1, the backlight unit includes an outer case 15, an optical film group 14, a light bar 13, a heat dispassion bar 12 and a backplane 11, wherein the optical film group 14 includes a diffusion plate 140, a prism plate 141, and another diffusion plate 142.

A guide plate 17 and a reflective plate 18 are also disposed on the heat dispassion bar 12;

The light emitted from the light bar 13 enters into the light guide plate 17 at a light incident surface (the surface directly opposite to the light bar 13) and enters into the optical film group 14 from a light exit surface. The optical film group 14 can make the light distribute more uniformly in order to improve the front luminance of the light. The role of the reflective plate 18 is to reflect the light to the light guide plate 17 as much as possible, and make it emits from the light exit surface.

The backplane 11 has a function for carrying all the components and ensuring the flatness of the backlight module. The outer case 15 is used for suppressing the optical film group 14 and blocking some light leakage.

However, in the convention art, the frame width of the LCD module becomes narrower. Correspondingly, the width of the outer case 15 also becomes narrower, and it is easier to upturn and eversion such that it generates a gap between the optical film group 14 and the outer case 15, which results in light leakage.

### SUMMARY OF THE INVENTION

To prevent the backlight unit from light leakage caused by upturn and eversion of the outer case, the present invention provide a naval structure of the backlight unit

An embodiment of the present invention provides a light leakage prevention backlight unit comprising:

a backplane for supporting the backlight unit;

a heat dispassion bar disposed on the backplane and comprising a horizontal plate having an edge and a vertical plate extending from the edge of the horizontal plate and having an outer side and an inner side;

a light bar disposed at the inner side of the vertical plate of the heat dispassion bar;

a reflective plate, a light guide plate, and an optical film group sequentially disposed on the horizontal plate of the heat dispassion bar from bottom to top, wherein a light incident surface of the light guide plate is directly opposite to the light bar;

an outer case disposed at the outer side of the heat dispassion bar and comprising multiple platforms, wherein the platforms are supported by the vertical plate of the heat dispassion bar, and some of the platforms are disposed above the outer peripheral of the optical film group; and

a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

Wherein, the outer case is a plastic case made of elastic material.

Wherein, the shape of the positioning piece is an arbitrary shape, and the positioning hole of the plastic case has the same shape as the positioning piece.

Wherein, the shape of the positioning piece is a rectangular or a polygonal.

Wherein, the light bar is a light emitting diode.

Another embodiment of the present invention provides a light leakage prevention LCD module comprising:

a front frame;

an LCD glass panel; and

a backlight unit, wherein the backlight unit comprises

a backplane for supporting the backlight unit;

a heat dispassion bar disposed on the backplane and comprising a horizontal plate having an edge and a vertical plate extending from the edge of the horizontal plate and having an outer side and an inner side;

a light bar disposed at the inner side of the vertical plate of the heat dispassion bar;

a reflective plate, a light guide plate, and an optical film group sequentially disposed on the horizontal plate of the heat dispassion bar from bottom to top, wherein a light incident surface of the light guide plate is directly opposite to the light bar;

an outer case disposed at the outer side of the heat dispassion bar and comprising multiple platforms, wherein the platforms are supported by the vertical plate of the heat dispassion bar, and some of the platforms are disposed above the outer peripheral of the optical film group; and

a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

Wherein the outer case is a plastic case made of elastic material.

Wherein, the shape of the positioning piece is an arbitrary shape, and the positioning hole of the plastic case has the same shape as the positioning piece.

Wherein, the shape of the positioning piece is a rectangular or a polygonal.

Another embodiment of the present invention provides an LCD device comprising:

a front housing;

a rear housing;

system components; and

an LCD module comprising a front frame, an LCD glass panel, and a backlight unit, wherein the backlight unit comprises

a backplane for supporting the backlight unit;

a heat dispassion bar disposed on the backplane and comprising a horizontal plate having an edge and a vertical plate extending from the edge of the horizontal plate and having an outer side and an inner side;

a light bar disposed at the inner side of the vertical plate of the heat dispassion bar;

a reflective plate, a light guide plate, and an optical film group sequentially disposed on the horizontal plate of the heat dispassion bar from bottom to top, wherein a light incident surface of the light guide plate is directly opposite to the light bar;

an outer case disposed at the outer side of the heat dispassion bar and comprising multiple platforms, wherein the platforms are supported by the vertical plate of the heat dispassion bar, and some of the platforms are disposed above the outer peripheral of the optical film group; and

a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

Wherein, the outer case is a plastic case made of elastic material.

Wherein, the shape of the positioning piece is an arbitrary shape, and the positioning hole of the plastic case has the same shape as the positioning piece.

In the backlight unit of the present invention, a positioning piece is disposed at t the heat dispassion bar, and the positioning piece can well fix the platform of the outer case to the heat dispassion bar so as to prevent the light leakage caused by eversion and upturn of the platforms of the outer case. The LCD module and LCD device provided by the present comprise the backlight unit so as to achieve light leakage phenomenon.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the skilled persons of ordinary skill in the art without creative effort, it can also obtain other figures according to these figures.

FIG. 1 is a schematic view illustrating a backlight unit in the prior art;

FIG. 2 is a schematic view illustrating a light leakage prevention backlight unit of the present invention;

FIG. 3 is a schematic view illustrating a light leakage prevention LCD module having of the present invention; and

FIG. 4 is a schematic view illustrating a light leakage prevention LCD device of the present invention.

### DETAILED DESCRIPTION OF THE PREFERRED EMBODIMENT

The present invention provides a novel structure of a backlight unit, and it can effectively prevent the outer case of the backlight unit from light leakage caused by upturn and eversion of the outer case.

The following combines the figures for illustrating the backlight unit of the present invention, an LCD module comprising the backlight unit, and a specific structure of an LCD device.

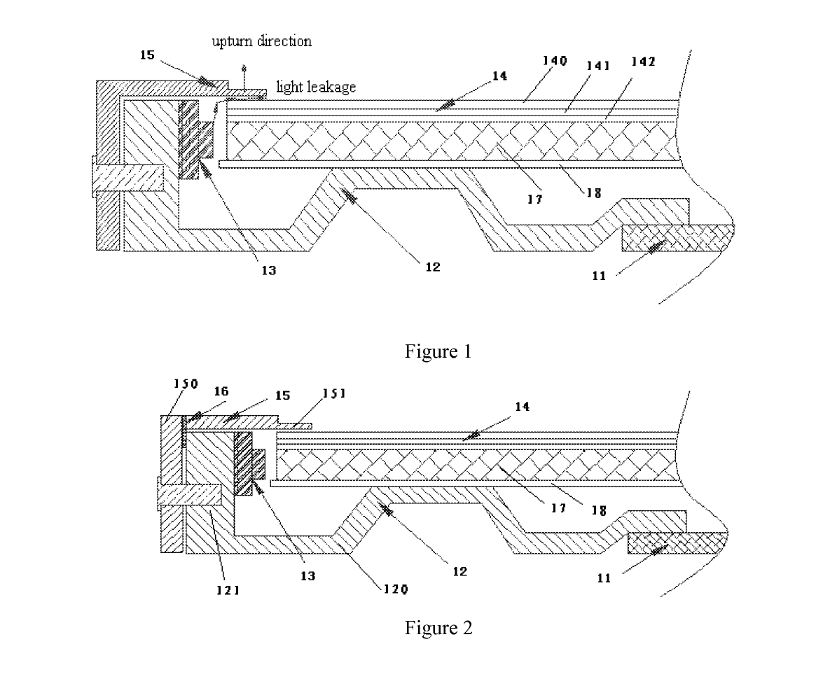

With reference to FIG. 2, it is a schematic view illustrating a light leakage prevention backlight unit of the present invention.

The backlight unit providing by the present embodiment includes: a backplane 11 for supporting the backlight unit; a heat dispassion bar 12 disposed on the backplane 11, and the heat dispassion bar 12 includes a horizontal plate 120 having an edge and a vertical plate 121 extending from the edge of the horizontal plate 120 and having an outer side and an inner side; a light bar 13 disposed at the inner side of the vertical plate 121 of the heat dispassion bar 12 to be a light source of the backlight unit.

From bottom to top, it sequentially provides with a reflective plate 18 on the horizontal plate 120 of the heat dispassion bar 12, a light guide plate 17, and an optical film group 14, wherein light incident surface of the light guide plate 17 is directly opposite to the light bar 13. The optical film group 14 is disposed on the light exit surface of the light guide plate 17 for transmission of the light generated from the light bar 3.

The outer case 15 is disposed at the outer side of the heat dispassion bar 12, and it includes an annular fixing frame 150 and multiple platforms 151. Wherein, the platforms 151 extend from the inner side of the annular fixing frame 150 and are parallel to the direction of the horizontal plate 120.

The platforms 151 are supported by the vertical plate 121 of the heat dispassion bar 12 and some of the platforms 151 are disposed above the outer peripheral of the optical film group 14.

A positioning piece 16 is disposed at an end portion of the vertical plate 121 of the heat dispassion bar 12. The platforms 151 of the outer case 15 provide with a positioning hole (not shown) corresponding to the location of the positioning piece 16. The positioning piece 16 cooperates with the corresponding positioning hole of the platforms 151 to fix the outer case 15 and the heat dispassion bar 12 together. Because the positioning piece 16 can well fix the platform 151 of the outer case 15, it prevents the platforms 151 of the outer case 15 from eversion and upturn in order to prevent light leakage.

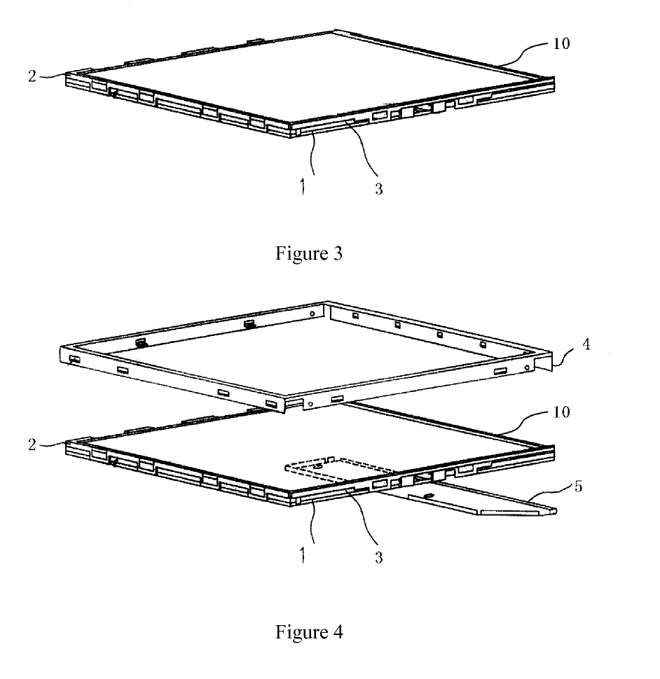

In a specific implementation, the outer case 15 is a plastic case made of elastic material. Wherein, the shape of the positioning piece 16 is an arbitrary shape, and the positioning hole of the plastic case has the same shape as the positioning piece 16. In a preferred embodiment, the shape of the positioning piece 16 is a rectangular or a polygonal.

Wherein, the light bar 13 is a light emitting diode. In another aspect, the present invention embodiment provides a light leakage prevention LCD module. With reference to FIG. 3, the light leakage prevention LCD module 10 of the present invention includes: a front frame 2, an LCD glass panel 3, and a backlight unit 1.

The backlight unit 1 and the LCD glass panel 3 are all disposed within the front frame 2. In addition, the front frame 2 and the LCD glass panel 3 are fixed each other by hooks and slots there between. The structure and function of the front frame 2 of the LCD module 10 and the LCD glass panel 3 are the conventional art known by the skilled person, and are not discussed again here.

It should be noted that the specific structure of the light leakage prevention LCD module of the present invention is not limited to the structure shown in FIG. 3. As long as the structure of the backlight unit 1 is the same shown in FIG. 2 and the function is the same as the foregoing embodiment, they are all within the scope of claims of the present invention.

In another aspect, another embodiment of the present invention provides an LCD device. With reference to FIG. 4, the LCD device of the present invention comprises: a front housing 4, a rear housing 5, an LCD module 10 and system components (not shown). It should be noted that the front housing 4, the rear housing 5, the LCD module 10, and the system components are fixed each other through screws or fasteners, which is familiar by skilled person in the art, and not repeated again here.

It should be noted that the specific structure of the light leakage prevention LCD device of the present invention is not limited to the structure shown in FIG. 4. As long as the structure comprises the backlight unit 1 shown in FIG. 2, and the function of the structure is the same as described at the foregoing embodiment, they are all within the scope of the claims of the present invention.

The backlight unit of the present invention provides with the positioning piece at the heat dispassion bar, and the positioning piece could well fix the platforms of the outer case to the heat dispassion bar in order to prevent the light leakage caused by eversion and upturn of the platforms of the outer case. The LCD module and the LCD device provided by the present invention include the backlight unit provided by the present invention so as to achieve the light leakage prevention effect.

The above content combines the preferred embodiments for detail description of the present invention. It is particularly pointed out that the above embodiments are only used to illustrate the present invention, and they are not used to limit the scope of the present invention. Other embodiments obtained under the premise of without paying creative labor by the person ordinary skill in the art are all belong to the claims of the present invention.

What is claimed is:

1. A light leakage prevention backlight unit comprising:
a backplane for supporting the backlight unit;
a heat dispassion bar disposed on the backplane and comprising a horizontal plate having an edge and a vertical plate extending from the edge of the horizontal plate and having an outer side and an inner side;
a light bar disposed at the inner side of the vertical plate of the heat dispassion bar;
a reflective plate, a light guide plate, and an optical film group sequentially disposed on the horizontal plate of the heat dispassion bar from bottom to top, wherein a light incident surface of the light guide plate is directly opposite to the light bar;
an outer case disposed at the outer side of the heat dispassion bar and comprising multiple platforms, wherein the platforms are supported by the vertical plate of the heat dispassion bar, and some of the platforms are disposed above the outer peripheral of the optical film group; and
a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

2. The backlight unit according to claim 1, wherein, the outer case is a plastic case made of elastic material.

3. The backlight unit according to claim 2, wherein, the shape of the positioning piece is an arbitrary shape, and the positioning hole of the plastic case has the same shape as the positioning piece.

4. The backlight unit according to claim 3, wherein, the shape of the positioning piece is a rectangular or a polygonal.

5. The backlight unit according to claim 4, wherein, the light bar is a light emitting diode.

6. A light leakage prevention LCD module comprising:
a front frame;
an LCD glass panel; and
a backlight unit, wherein the backlight unit comprises
a backplane for supporting the backlight unit;
a heat dispassion bar disposed on the backplane and comprising a horizontal plate having an edge and a vertical plate extending from the edge of the horizontal plate and having an outer side and an inner side;
a light bar disposed at the inner side of the vertical plate of the heat dispassion bar;
a reflective plate, a light guide plate, and an optical film group sequentially disposed on the horizontal plate of the heat dispassion bar from bottom to top, wherein a light incident surface of the light guide plate is directly opposite to the light bar;
an outer case disposed at the outer side of the heat dispassion bar and comprising multiple platforms, wherein the platforms are supported by the vertical plate of the heat dispassion bar, and some of the platforms are disposed above the outer peripheral of the optical film group; and
a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

7. The light leakage prevention LCD module according to claim 6, wherein the outer case is a plastic case made of elastic material.

8. The light leakage prevention LCD module according to claim 7, wherein, the shape of the positioning piece is an arbitrary shape, and the positioning hole of the plastic case has the same shape as the positioning piece.

9. The light leakage prevention LCD module according to claim 8, wherein, the shape of the positioning piece is a rectangular or a polygonal.

10. An LCD device comprising:
a front housing;
a rear housing;
system components; and
an LCD module comprising a front frame, an LCD glass panel, and a backlight unit, wherein the backlight unit comprises
a backplane for supporting the backlight unit;
a heat dispassion bar disposed on the backplane and comprising a horizontal plate having an edge and a vertical plate extending from the edge of the horizontal plate and having an outer side and an inner side;
a light bar disposed at the inner side of the vertical plate of the heat dispassion bar;
a reflective plate, a light guide plate, and an optical film group sequentially disposed on the horizontal plate of the heat dispassion bar from bottom to top, wherein a light incident surface of the light guide plate is directly opposite to the light bar;
an outer case disposed at the outer side of the heat dispassion bar and comprising multiple platforms, wherein the platforms are supported by the vertical plate of the heat dispassion bar, and some of the platforms are disposed above the outer peripheral of the optical film group; and
a positioning piece disposed at an end portion of the vertical plate of the heat dispassion bar, wherein the platforms of the outer case provide with a positioning hole corresponding to the location of the positioning piece, and the positioning piece cooperates with the corresponding positioning hole of the platforms to fix the outer case and the heat dispassion bar together.

11. The LCD device according to claim 10, wherein, the outer case is a plastic case made of elastic material.

12. The LCD device according to claim 11, wherein, the shape of the positioning piece is an arbitrary shape, and the positioning hole of the plastic case has the same shape as the positioning piece.
